(19) United States
(12) Patent Application Publication
(10) Pub. No.: US 2026/0023768 A1
(43) Pub. Date: Jan. 22, 2026

(54) AUTOMATED LINKING OF FEATURES WITH COMMENTS USING MACHINE LEARNING BASED LANGUAGE MODELS

(71) Applicant: ProductBoard, Inc., San Francisco, CA (US)

(72) Inventors: Dominik Ilichman, Prague (CZ); Michal Matyscak, Brno (CZ); Efstathios Eleftheriadis, London (GB)

(21) Appl. No.: 18/799,830

(22) Filed: Aug. 9, 2024

(30) Foreign Application Priority Data
Jul. 16, 2024 (GR) 20240100497

(51) Int. Cl. G06F 16/33; G06F 40/40

(52) U.S. Cl. CPC G06F 16/3344; G06F 40/40

(57) ABSTRACT

A system, for example, an online system uses a machine learning based language model, for example, a large language model (LLM) to rank features of items. The system receives comments from users. Each comment represents user feedback received via a channel of the online system, for example, via email, via a chat interface, and so on. The system links comments with features using a machine learning based language model. The system stores a link representing an association between a feature and a comment and determines aggregate information describing links for each feature. The system determines a priority for a feature based on the aggregate information describing links for the feature and sends information describing the priority of the feature.

### CROSS-REFERENCE TO RELATED APPLICATIONS

This application claims the benefit of and priority to Greek Patent Application No. 20240100497, filed 16 Jul. 2024, which is hereby incorporated by reference in its entirety.

### TECHNICAL FIELD

One or more aspects described herein relate generally to machine learning based language models, and more specifically to linking of features with user comments using machine learning based language models.

### BACKGROUND

Industries such as manufacturing industries, software industries, and so on build items. These items may be developed over time. For example, a complex software system may be built over multiple releases. In each release, several features may be planned and developed for the software system. Users of these features often provide feedback in the form of unstructured natural language text. Such a system may store a large corpus of documents comprising unstructured data representing user comments that get updated on a regular basis. Conventional techniques for processing such data comprise techniques such as text search followed by manual review. Text search techniques may be based on search that allow keyword based search through a corpus of documents. If the data comprises a large number of documents, each document representing user comments, keyword based search for processing the data can be inefficient. For example, several documents may match a keyword search, thereby requiring significant manual effort to process the search results.

### SUMMARY

In accordance with one or more aspects of the disclosure, a system, for example, an online system links features with comments provided by users, for example, for providing user feedback. The online system stores information describing items and features describing each item. The system may store a hierarchy of features for each item. The system receives comments from users, each comment representing user feedback received via a channel of the online system, for example, via email, via a chat interface, and so on. The system links comments with features using a machine learning based language model. The system generates a prompt describing one of more features and one or more comments. The prompt is provided to the machine learning based language model for execution. A response generated by the machine learning based language model is received. The response describes associations between features and comments. The system stores a link representing an association between a feature and a comment identified based on the response. The system determines aggregate information describing links for each feature. The system determines a priority for a feature based on the aggregate information. The system may take actions based on the priority of the feature, for example, scheduling tasks associated with the feature such as implementation of the feature. The actions may be performed in response to user input, for example, requests received by the system from users for triggering various downstream actions/decisions.

According to an embodiment, the system stores the features and/or the comments in a vector database. The system generates a vector representation of the features or the comments and stores the vector representation in a vector database. A vector representation of a feature or a comment may be generated by providing the feature or comment to a neural network as input and extracting an embedding from a hidden layer of the neural network.

According to an embodiment, the system receives a comment representing user feedback, generates a vector representation of the comment, and identifies one or more features relevant to the comment from the vector database. The system identifies features relevant to the comment based on a vector distance of vector representations the features from the vector representation of the comment.

According to an embodiment, the system receives information describing a new feature and generates a vector representation of the new feature. The system identifies comments relevant to the features from the vector database based on a vector distance of vector representations of the comments from the vector representation of the new feature.

Embodiments of the invention include computer-implemented methods described herein, non-transitory computer readable storage media storing instructions for performing steps of the methods disclosed herein, and systems comprising one or more computer processors and computer readable non-transitory storage medium to perform steps of the computer-implemented methods disclosed herein.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIG. 3 is a flowchart representing the overall process of automatically linking features and comments, in accordance with one or more embodiments.

FIG. 4 is a flowchart representing the overall process of receiving comments and linking them with appropriate features, in accordance with one or more embodiments.

FIG. 5 is a flowchart representing the overall process of receiving a new feature or a modification to a feature and linking the feature with comments, in accordance with one or more embodiments.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

An online system stores information describing features of items, for example, features of products being developed. The features may be organized as a hierarchy. The online system receives comments from users, for example, comments representing user feedback. The comments may be received via channels such as email channel, chatbots, phone calls, and so on. The comment includes unstructured text specified using natural language text and may include additional metadata. The online system uses a machine learning based language model, for example, a large language model (LLM) to link features of items with the comments. The system aggregates information describing comments for individual features and uses the aggregate information to prioritize the features. For example, a priority of a feature may be used to schedule projects associated with development of the feature. According to an embodiment, the item may be an article of manufacture being developed or modified by an industry, for example, a software product developed by software industry. According to an embodiment, the item may be a service performed by an organization and the features may represent modifications or additions to the service. A comment may also be referred to herein as a note, a user feedback, or an insight.

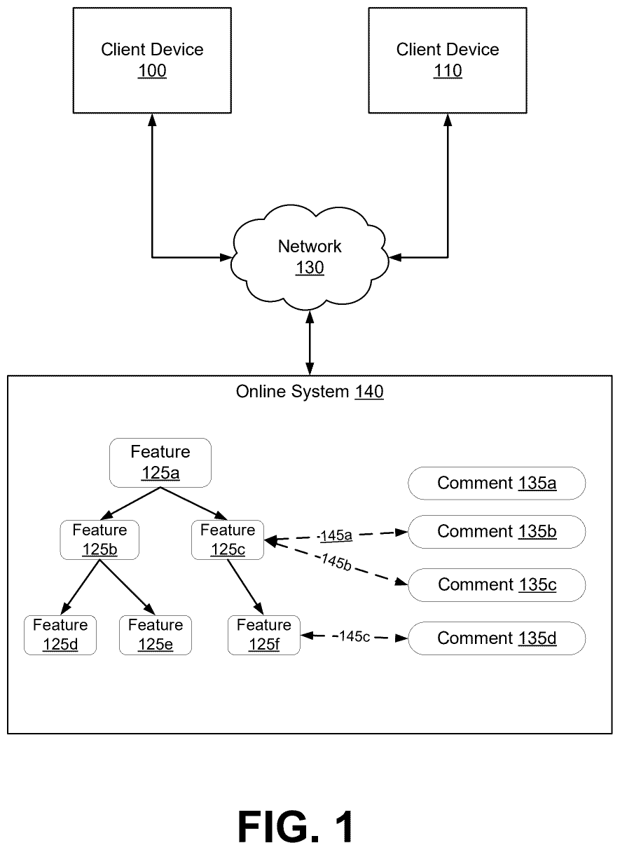

FIG. 1 illustrates an example system environment for an online system 140, in accordance with one or more embodiments. The system environment illustrated in FIG. 1 includes client devices 100, 110, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention. Additionally, any number of client devices may interact with the online system 140.

The client device 100 allows users to interact with the online system 140 via the network 130. The client device 100 can be a personal or mobile computing device, such as a smartphone, a tablet, a laptop computer, or desktop computer. In some embodiments, the client device 100 executes a client application that uses an application programming interface (API) to communicate with the online system 140. The client device 100 presents a user interface that allows the user to interact with the online system 140.

The online system 140 receives information from the user via the client device 100, for example, information describing features 125 of items or comments 135 representing user feedback. According to an embodiment, the client device 100 presents an application comprising a user interface that allows a user to specify a hierarchy of features. The hierarchy of features provides a mechanism of organizing features. The hierarchy of features may be defined based on different criteria, for example, a hierarchy of features related to a product may be defined based on teams working on the product of based on functionality. For example, the online system 140 receives a hierarchy of features for an item as illustrated in FIG. 1. A feature may comprise other features. For example, the feature 125a includes features 125b and 125c; the feature 125b includes features 125d and 125e; and the feature 125c includes a features 125f. For example, the item may represent a software product and the feature 125a may represent a particular component C1 being added to the software product. The features 125b and 125c that occur below the feature 125a in the hierarchy may represent sub-components C2 and C3 that are part of the component C1. Similarly features 125d and 125e may represent sub-components C4 and C5 that are part of component C2 and feature 125f represents a component C6 that is part of component C3. The feature may not add new components but may modify existing components of a software product or may modify some components and add other components.

The online system 140 receives comments 135a, 135b, 135c, 135d from users via client devices 100. Each comment represents user feedback that may be associated with one or more items. Each comment may represent user feedback associated with one or more features of an item. According to an embodiment, the online system 140 pre-processes the comment to remove certain tags or message headers and so on.

The online system 140 uses machine learning based language models to identify features associated with each comment. Accordingly, the online system 140 determines links 145 between features and comments. A link represents an association between a feature and a comment. For example, FIG. 1 shows a link 145a between feature 125c and comment 135b, a link 145b between feature 125c and comment 135c, and a link 145c between feature 125f and comment 135d. A feature may be linked to multiple comments and similarly, a comment may be linked to multiple features. Similarly, if the online system 140 receives a new feature, the online system 140 identifies comments associated with the new feature. Furthermore, if the description of a feature is modified, the online system 140 recomputes the associations between the modified feature. Accordingly, the online system 140 may unlink some comments that were linked to the feature and link other comments to the feature.

A comment may indicate whether a user likes a particular feature, whether the user dislikes a feature, or a suggestion by the user describing a possible modification of the feature. The online system 140 may analyze various comments associated with each feature to determine whether users like certain feature or whether users are not interested or dislike a feature. The online system 140 may analyze comments to determine whether users are interested in a new feature or are not interested in a feature or dislike a feature. The online system 140 may rank features based on the analysis of comments such that the rank of a feature represents the significance or the feature. For example, certain features may be determined to be more significant compared to other features. Accordingly, the online system 140 determines priority of each feature based on the analysis of the comments.

The priority of the features may be used for downstream processing, for example, for scheduling resources for each feature. For example, an organization may prioritize implementation of various features and may use the analysis to determine which features are implemented first or which features are allocated more resources based on their assigned priorities. The online system 140 may display the significance of each feature via a user interface, for example, a user interface that ranks the features based on their priorities or displays high priority features more prominently compared to low priority features. The online system 140 may schedule tasks associated with features based on their priority, for example, tasks associated with a feature F1 that is higher priority may be scheduled ahead of tasks associated with a feature F2 that is lower priority. The online system 140 may make recommendations regarding scheduling of tasks associated with features based on their priority.

The online system 140 may make above decisions automatically or may recommend certain decisions and let a user determine whether the decision is accepted to rejected. The online system 140 may simply display information describing the priority of features via a user interface and let a user make above decisions.

The techniques disclosed improve the efficiency of execution as well as effectiveness of conventional processes associated with features of items. The online system 140 may store hundreds or thousands of features associated with items and may receive thousands of comments on an ongoing basis, for example on a daily basis. Each comment may be associated with one or more features of an item. Identifying features associated with each comment may be a cumbersome task if performed manually. Even if the associations are performed automatically, the associations may be erroneous since user comments are specified using natural language based unstructured text that is difficult to analyze programmatically. As a result, erroneous analysis of the user comments may result in incorrect prioritization of the features that may result in downstream problems, for example, inaccurate scheduling of implementation of features or improper allocation of resources to features.

The client devices 100 and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

### System Architecture

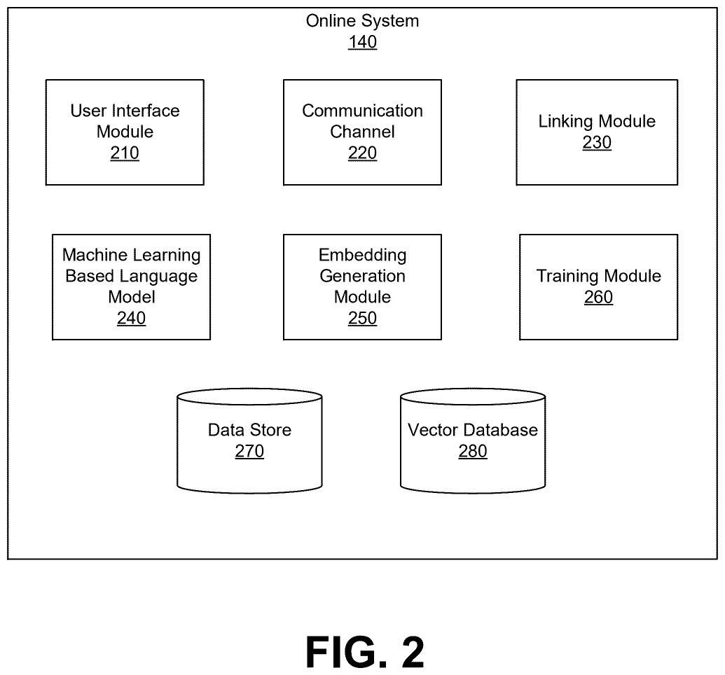

FIG. 2 illustrates an example system architecture for an online system 140, in accordance with some embodiments. The online system 140 illustrated in FIG. 2 includes a user interface module 210, a communication channel 220, a linking module 230, a machine learning based language model 240, an embedding generation module 250, a training module 260, a data store 270, and a vector database 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The user interface module 210 configures user interfaces for presentation to a user via a client device 100. The user interfaces configured by the user interface module 210 allow users to provide information to the online system 140, for example, description of various items, description of various features of an item, and so on. According to an embodiment, the user interfaces configured by the user interface module 210 allow users to specify a hierarchical relation between features to build a feature hierarchy as illustrated in FIG. 1.

The communication channels 220 allow users to provide comments associated with various features of items. An example of a communication channel 220 used by users to provide comments is an email channel. Accordingly, users send an email comprising a natural language description representing the user comment. Another example, of a communication channel 220 is an online chat, for example, a chat interface with an agent or a chatbot that allows users to provide comments. Another example, of a communication channel 220 is a phone interface that allows users to provide audio input. The communication channel 220 may receive an audio signal and generate a transcript of the audio signal for use as the natural language based text description. Another example, of a communication channel 220 is a video channel that allows users to use a video interface to provide comments. The communication channel 220 extracts the audio signal from the video input and transcribes the audio signal to generate a comment represented as natural language based text.

The data store 270 stores data used by the online system 140. For example, the data store 270 stores description of items, description of features, comments, and so on. The data store 270 may also store trained machine learning models trained by the training module 260. For example, the data store 270 may store the set of parameters for a trained machine learning model on one or more non-transitory, computer-readable media. The data store 270 uses computer-readable media to store data and may use databases to organize the stored data.

According to an embodiment, the online system stores information such as feature description and comments in a vector database 280. According to an embodiment, the embedding generation module 250 generates a vector representation of natural language text corresponding to a feature description or a comment. The vector representation of a natural language text may be an embedding representing an output of a hidden layer of a neural network trained to encode the natural language description. According to an embodiment, the embedding generation module 250 requests the machine learning based language model 240 to generate the embeddings representing the vector corresponding to a natural language text. The vector database 280 allows the online system 140 to identify natural language texts that are similar to an input natural language text. The vector database 280 identifies natural language texts having vector representations that are within a threshold vector distance of an input natural language text. The vector distance may be based on a cosine similarity metric. The online system 140 may provide a vector representation of a feature to the vector database 280 to determine all comments that are similar to the feature. The online system 140 may provide a vector representation of a comment to the vector database 280 to determine all features that are similar to the comment.

In one or more embodiments, the machine learning based language model 240 is a large language model (LLM) trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLMs, the LLM is able to perform various tasks and synthesize and formulate output responses based on information extracted from the training data.

In one or more embodiments, the machine learning based language model 240 is a transformer neural network architecture. Specifically, the transformer model is coupled to receive sequential data tokenized into a sequence of input tokens and generates a sequence of output tokens depending on the task to be performed. In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the machine learning based language model 240 can be configured as any other appropriate architecture including, but not limited to, long short-term memory (LSTM) networks, Markov networks, BART, generative-adversarial networks (GAN), diffusion models (e.g., Diffusion-LM), and the like.

The training module 260 trains machine learning models used by the online system 140. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

In one or more embodiments, the online system 140 receives a pre-trained machine learning based language model 240 and the training module 260 additionally fine-tunes parameters of the machine learning based language model 240 using multiple instances of training data. An instance in the training data may include strings or sentences obtained by concatenating inputs and expected outputs of the machine learning based language model. For example, the training data may comprise natural language questions received from users with lists of items, item types, or categories of items associated with the natural language question. The machine learning based language model receives an input sentence with missing tokens from the output portion of the input sentence and predicts the missing tokens. A loss function is computed by aggregating loss values obtained from the predicted tokens and the known tokens of the output portion of the sentences provided as training data. The errors obtained from the loss function are backpropagated to update parameters of the machine-learned model.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The training module 260 generates the set of parameters for a machine learning model by “training” the machine learning model. Once trained, the machine learning model uses the set of parameters to transform inputs into outputs.

The training module 260 trains a machine learning model based on a set of training examples. Each training example includes input data to which the machine learning model is applied to generate an output. For example, each training example may include user data, item data, or order data. In some cases, the training examples also include a label which represents an expected output of the machine learning model. In these cases, the machine learning model is trained by comparing its output from input data of a training example to the label for the training example.

The training module 260 may apply an iterative process to train a machine learning model whereby the training module 260 trains the machine learning model on each of the set of training examples. To train a machine learning model based on a training example, the training module 260 applies the machine learning model to the input data in the training example to generate an output. The training module 260 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The training module 260 updates the set of parameters for the machine learning model based on the score generated by the loss function. For example, the training module 260 may apply gradient descent to update the set of parameters.

The machine-learned models may already be trained by a separate entity from the entity responsible for the online system 140. In another embodiment, when the model serving system 150 is included in the online system 140, the training module 260 may further train parameters of the machine-learned model based on data specific to the online system 140 stored in the data store 270. As an example, the training module 260 may obtain a pre-trained transformer language model and further fine tune the parameters of the transformer model using training data stored in the data store 270.

### Process of Automatic Linking

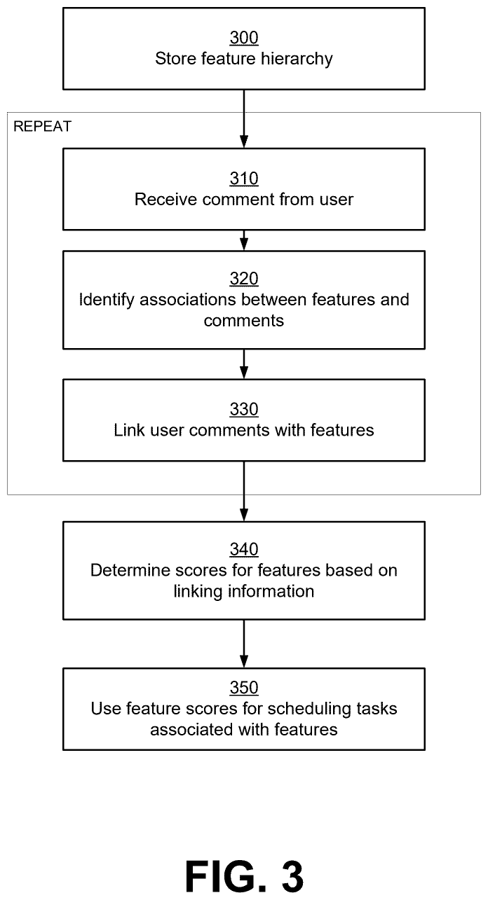

FIG. 3 is a flowchart representing the overall process of automatically linking features and comments, in accordance with one or more embodiments. Alternative embodiments may include more, fewer, or different steps from those illustrated in FIG. 3, and the steps may be performed in a different order from that illustrated in FIG. 3. These steps may be performed by a system (e.g., online system 140). Additionally, each of these steps may be performed automatically by the online system without human intervention.

The online system 140 stores 300 a feature hierarchy, for example, description of features of an item and the relations between features. The description of features may be stored in the vector database 280 in vector form. The hierarchical relation between features may be stored in a relational database as pairs of features having parent child relations.

The online system 140 repeats the steps 310, 320, and 330 as comments are received from users. The online system 140 receives 310 one or more comments from users via one or more communication channels 220. The online system 140 identifies 320 associations between features and comments received from users using the machine learning based language model 240. The online system 140 links 330 the received user comments with features and stores the linking information, for example, in the data store 270.

The online system 140 analyzes the linking information to determine 340 scores for features based on the linking information. According to an embodiment, the online system 140 computes the number of comments linked with each feature and uses the aggregate number of comments linked to a feature as a measure of significance of the feature. Accordingly, the priority of each feature is determined based on the aggregate linking information for each feature.

According to an embodiment, the significance of a feature is determined as a weighted aggregate of scores associated with comments linked to the feature. For example, each comment may be analyzed to determine a comment score of the comment with respect to a particular feature. The online system 140 may perform sentiment analysis to determine a comment score of the comment with respect to the particular feature. The online system 140 determines whether a comment represents positive feedback for the feature or negative feedback for the feature. The comments are weighted appropriately based on the type of feedback. For example, comments with positive feedback may be assigned higher weight compared to comments with neutral or negative feedback. The weighted comment scores are aggregated to determine an aggregate feature score representing a significance of the feature. According to an embodiment, the online system 140 determines a strength of sentiment in each comment. For example, the online system 140 determines how positive a positive comment is and accordingly determines a value of the positive weight of the positive comment. Similarly, the online system 140 may determine a strength of a negative feedback and accordingly determines a value of the negative weight of the negative comment.

The online system 140 uses 350 the scores of features for prioritizing tasks associated with each feature. For example, a feature with higher score may receive higher priority and accordingly, tasks associated with that feature may be prioritized over tasks associated with features having lower priority.

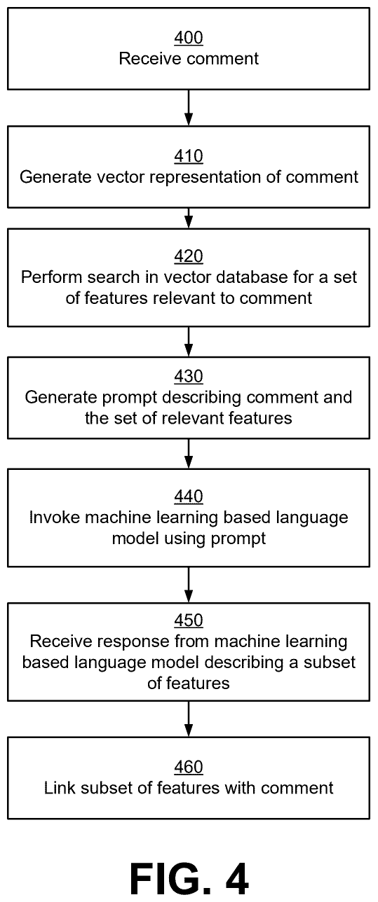

FIG. 4 is a flowchart representing the overall process of receiving comments and linking them with appropriate features, in accordance with one or more embodiments. Alternative embodiments may include more, fewer, or different steps from those illustrated in FIG. 4, and the steps may be performed in a different order from that illustrated in FIG. 4. These steps may be performed by a system (e.g., online system 140). Additionally, each of these steps may be performed automatically by the online system without human intervention.

The online system 140 receives 400 a comment via one of the communication channels 220. The comment comprises natural language text and may represent user feedback associated with one or more features. The embedding generation module 250 generates 410 a vector representation of the comment received. The embedding generation module 250 may provide the comment as input to a neural network trained to encode natural language inputs and extracts the embeddings from a hidden layer of the neural network as the vector representation of the comment.

According to an embodiment, the online system 140 generates a summary for each comment. The online system 140 may generate summary for a comment using a machine learning based language model 240. Accordingly, the online system 140 generates a prompt comprising the comment and requesting the machine learning based language model 240 to generate a summary of the comment. The online system 140 provides the prompt to the machine learning based language model 240 and receives a response generated by executing the machine learning based language model 240. The online system 140 extracts the summary from the response.

According to an embodiment, the online system 140 generates a vector representation V1 of a comment and a vector representation V2 of the summary of the comment. The online system 140 combines the two vector V1 and V2, for example, by determining an average vector based on the two vectors V1 and V2. The average vector may be determined by computing the average values of corresponding elements of the vector. The online system 140 may store the average vector value in the vector database as the vector representation of the comment. The online system 140 may use the average vector for identifying features relevant to the comment based on vector distance between the average vector and the vector representations of features.

The linking module 230 performs a search in the vector database 280 for features that are associated with the comment received. According to an embodiment, the vector database 280 returns a set of features that have vector representations that are within a threshold distance of the vector representation of the comment. The vector database 280 may rank features based on their vector distance from the vector representation of the comment and select the top few features. According to an embodiment, the linking module 230 uses the set of features determined to be associated with the comment as the set of features that are linked to the comment.

According to other embodiments, the linking module 230 further narrows down the list of features associated with the comment using the machine learning based language model 240. Accordingly, the linking module 230 generates 430 a prompt specifying the comment and the set of features extracted from the vector database 280 as being associated with the comment and requests the machine learning based language model 240 to identify a subset of the features that are closely related to the comment. The linking module 230 may also specify in the prompt that the machine learning based language model 240 should also describe the type of feedback provided in the comment for a particular feature, for example, whether the feedback is positive or negative and to optionally provide a measure of how positive or negative the feedback is for the feature.

The linking module 230 invokes 440 the machine learning based language model 240 using the prompt. If the machine learning based language model 240 is executing in an external system, the linking module 230 provides the prompt to the external system and receives the response by invoking the API (application programming interfaces) of the external system. If the machine learning based language model 240 is available within the online system 140 the linking module 230 may simply execute the machine learning based language model 240, for example, as a function or method invocation.

The linking module 230 receives 450 the response of the machine learning based language model 240 obtained by executing the machine learning based language model 240 using the prompt. The linking module 230 extracts as subset of features determined by the machine learning based language model 240 as being most relevant to the comment. The linking module 230 may also extract any additional information provided by the machine learning based language model 240 for example, the type of feedback and/or a degree of intensity of the feedback.

The linking module 230 links 460 the features of the subset of features determined to be most relevant to the comment with the comment. For example, the linking module 230 may store an association in a database relating each feature of the subset of feature with the comment. The linking module 230 may further update any statistics describing the linking information for each feature. The linking module 230 may update the statistics periodically or in a batch mode, for example, after a number of comments are processed. For example, if the linking information for a feature is a score determined as a weighted aggregate of scores associated with comments linked to the feature, the linking module 230 may update the weighted aggregate score based on the comments that were recently linked to the feature that have not previously been incorporated into the weighted aggregate score of the feature.

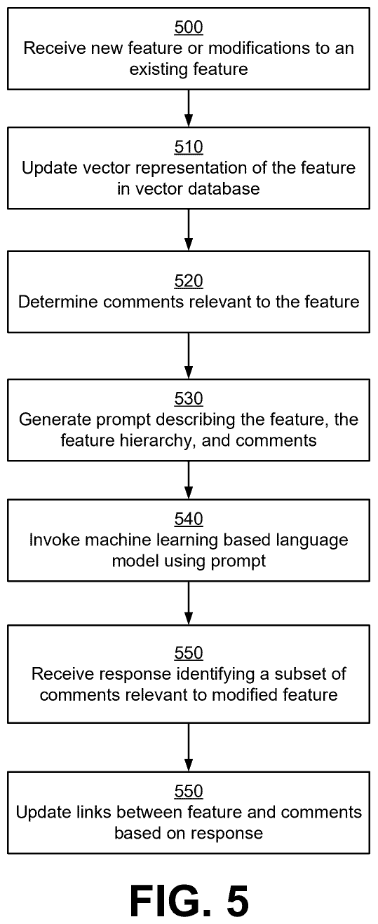

FIG. 5 is a flowchart representing the overall process of receiving a new feature or a modification to a feature and linking the feature with comments, in accordance with one or more embodiments. Alternative embodiments may include more, fewer, or different steps from those illustrated in FIG. 5, and the steps may be performed in a different order from that illustrated in FIG. 5. These steps may be performed by a system (e.g., online system 140). Additionally, each of these steps may be performed automatically by the online system without human intervention.

The online system 140 receives a new feature or modifications to an existing feature. The online system 140 determines the vector representation of the feature, for example, by providing the description of the feature to a neural network and extracting an embedding as the output of a hidden layer of the neural network. The online system 140 adds the vector representation of the feature to the vector database 280 if it is a new feature or updates 510 the vector representation of the feature in the vector database 280 if it is an existing feature.

The online system 140 determines 520 comments relevant to the feature using the vector database. According to an embodiment, the online system 140 identifies a set of comments that have vector representations in the vector database that are within a threshold distance of the vector representation of the feature, for example, based on a vector distance metric such as cosine similarity metric. According to an embodiment, the online system 140 links the feature to the set of comments identified as relevant to the feature using the vector database 280.

According to an embodiment, the linking module 230 further determines a subset of the comments relevant to the feature by using the machine learning based language model 240. Accordingly, the linking module 230 generates 530 a prompt describing the feature and one or more comments from the set of comments to determine whether the comments are relevant to the feature. The linking module 230 may further request the machine learning based language model 240 to determine a type of feedback represented by the comment, for example, positive feedback, neutral feedback, or negative feedback. The linking module 230 may further request the machine learning based language model 240 to determine a degree of intensity of the feedback represented by the comment, for example, mildly positive feedback, highly positive feedback or mildly negative feedback or highly negative feedback.

The linking module 230 invokes 540 the machine learning based language model 240 using the prompt. If the machine learning based language model 240 is executing in an external system, the linking module 230 provides the prompt to the external system and receives the response by invoking the API (application programming interfaces) of the external system. If the machine learning based language model 240 is available within the online system 140 the linking module 230 may simply execute the machine learning based language model 240, for example, as a function or method invocation.

The linking module 230 receives 550 the response of the machine learning based language model 240 obtained by executing the machine learning based language model 240 using the prompt. The linking module 230 extracts as subset of comments determined by the machine learning based language model 240 as being most relevant to the feature. The linking module 230 may also extract any additional information provided by the machine learning based language model 240 for example, the type of feedback and/or a degree of intensity of the feedback represented by the comment for the feature.

The linking module 230 adds/removes/updates 550 the links between the feature and the subset of comments based on the response receive from the machine learning based language model 240. The linking module 230 may further update the linking information of the feature based on the links that were added/removed/modified.

According to an embodiment, the new feature received may not include a detailed description. For example, the new feature may be received with no description but only a title and a position of the new feature in the feature hierarchy. The online system 140 matches comments with the new feature based on the title of the feature and the position of the new feature in the feature hierarchy. For example, the online system 140 may generate prompts requesting comments relevant to the new feature by including the title of the new feature and the position of the new feature in the feature hierarchy. After a threshold number of comments are matched with the new feature, the online system 140 generates a description of the new feature based on the comments matching with the new feature so far. Accordingly, the online system 140 generates a prompt including the title of the new feature, the position of the new feature in the feature hierarchy, and the comments linked to the new feature. The prompt requests the machine learning based language model 240 to generate a summary of the new feature. The online system 140 provides the prompt to the machine learning based language model 240 and executes the machine learning based language model 240 to generate a response. The online system 140 extracts the description of the new feature from the response and saves it as metadata for the new feature.

### Additional Considerations

The foregoing description of the embodiments has been presented for the purpose of illustration; many modifications and variations are possible while remaining within the principles and teachings of the above description. The foregoing description of the embodiments has been presented for the purpose of illustration; many modifications and variations are possible while remaining within the principles and teachings of the above description. Embodiments comprise computer-implemented methods comprising steps of processes described herein. Embodiments comprise non-transitory computer readable storage medium storing instructions that when executed by one or more computer processors cause the one or more computer processors to perform steps of methods disclosed herein. Embodiments comprise computer system comprising one or more computer processors and a non-transitory computer readable storage medium storing instructions that when executed by one or more computer processors cause the one or more computer processors to perform steps of method disclosed herein.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A computer-implemented method comprising:
storing, by an online system, information describing an item, the information comprising a plurality of features of the item;
receiving a plurality of comments from users, each comment representing user feedback received via a channel from a plurality of channels of the online system;
linking comments from the plurality of comments with features of the plurality of features, comprising:
generating a vector representation of each of the plurality of comments;
generating a vector representation of each of the plurality of features;
for each of the plurality of features,
identifying a set of comments whose vector representations are similar to the vector representation of the feature;
generating a prompt for input to a machine learning based language model, the prompt describing the feature and corresponding one or more comments whose vector representations are identified as similar to the vector representation of the feature, the prompt instructs the machine learning based language model to determine whether each of the one or more comments is associated with the feature,
providing the prompt to the machine learning based language model for execution of the machine learning based language model,
receiving a response generated by the machine learning based language model based on the prompt, the response describing an association between the feature and at least one of the one or more comments, and
storing a link representing the association between the feature and the at least one of the one or more comments;
determining aggregate information describing linked one or more comments for each feature from the plurality of features;
determining a priority for a feature from the plurality of features based on the aggregate information describing the linked one or more comments for the feature; and
in response to determining the feature as high-priority, prioritizing processing of incoming comments associated with the feature.

2. The computer-implemented method of claim 1, further comprising:
for each of the plurality of features, generating a vector representation of the feature and storing the vector representation of the feature in a vector database.

3. The computer-implemented method of claim 2, further comprising:
receiving a comment representing user feedback;
generating a vector representation of the comment; and
identifying, from the vector database, the one or more features based on a vector distance of vector representations of each of the one or more features from the vector representation of the comment.

4. The computer-implemented method of claim 2, further comprising:
for each of the plurality of comments, generating a vector representation of the comment and storing the vector representation of the comment in one or more vector databases.

5. The computer-implemented method of claim 2, further comprising:
receiving information describing a new feature;
generating a vector representation of the new feature; and
identifying, from the vector database, the one or more comments based on a vector distance of vector representations of each of the one or more comments from the vector representation of the new feature.

6. The computer-implemented method of claim 5, wherein the information describing the new feature represents a title of the feature, the computer-implemented method further comprising:
linking a set of comments to the new feature; and
generating using the machine learning based language model, a description of the feature based on the set of comments linked to the new feature.

7. The computer-implemented method of claim 1, further comprising:
receiving a modification to information describing a particular feature;
responsive to received the modification, recomputing links between the particular feature and the plurality of comments;
recomputing aggregate information describing links for the particular feature; and
recomputing the priority for the particular feature based on the recomputed aggregate information describing links for the particular feature.

8. The computer-implemented method of claim 1, wherein the plurality of features form a feature hierarchy, wherein the prompt comprises, for each of the one or more features, information describing a position of the feature in the feature hierarchy.

9. The computer-implemented method of claim 1, wherein a comment received from a user represents:
an email communication received from the user,
a natural language text received from the user via a chat interface, or
a transcript of a call received from the user.

10. A non-transitory computer readable storage medium storing instructions that when executed by one or more computer processors cause the one or more computer processors to perform steps comprising:
storing, by an online system, information describing an item, the information comprising a plurality of features of the item;
receiving a plurality of comments from users, each comment representing user feedback received via a channel from a plurality of channels of the online system;
linking comments from the plurality of comments with features of the plurality of features, comprising:
generating a vector representation of each of the plurality of comments;
generating a vector representation of each of the plurality of features;
for each of the plurality of features,
identifying a set of comments whose vector representations are similar to the vector representation of the feature;
generating a prompt for input to a machine learning based language model, the prompt describing the feature and corresponding one or more comments whose vector representations are identified as similar to the vector representation of the feature, the prompt instructs the machine learning based language model to determine whether each of the one or more comments is associated with the feature,
providing the prompt to the machine learning based language model for execution of the machine learning based language model,
receiving a response generated by the machine learning based language model based on the prompt, the response describing an association between the feature and at least one of the one or more comments, and
storing a link representing the association between the feature and the at least one of the one or more comments;
determining aggregate information describing linked one or more comments for each feature from the plurality of features;
determining a priority for a feature from the plurality of features based on the aggregate information describing the linked one or more comments for the feature; and
in response to determining the feature as high-priority, prioritizing processing of incoming comments associated with the feature.

11. The non-transitory computer readable storage medium of claim 10, the instructions causing the one or more computer processors to further perform steps comprising:
for each of the plurality of features, generating a vector representation of the feature and storing the vector representation of the feature in a vector database.

12. The non-transitory computer readable storage medium of claim 11, the instructions causing the one or more computer processors to further perform steps comprising:
receiving a comment representing user feedback;
generating a vector representation of the comment; and
identifying, from the vector database, the one or more features based on a vector distance of vector representations of each of the one or more features from the vector representation of the comment.

13. The non-transitory computer readable storage medium of claim 11, the instructions causing the one or more computer processors to further perform steps comprising:
for each of the plurality of comments, generating a vector representation of the comment and storing the vector representation of the comment in one or more vector databases.

14. The non-transitory computer readable storage medium of claim 11, the instructions causing the one or more computer processors to further perform steps comprising:
receiving information describing a new feature;
generating a vector representation of the new feature; and
identifying, from the vector database, the one or more comments based on a vector distance of vector representations of each of the one or more comments from the vector representation of the new feature.

15. The non-transitory computer readable storage medium of claim 14, wherein the information describing the new feature represents a title of the feature, the instructions causing the one or more computer processors to further perform steps comprising:
linking a set of comments to the new feature; and
generating using the machine learning based language model, a description of the feature based on the set of comments linked to the new feature.

16. The non-transitory computer readable storage medium of claim 10, the instructions causing the one or more computer processors to further perform steps comprising:
receiving a modification to information describing a particular feature;
responsive to received the modification, recomputing links between the particular feature and the plurality of comments;
recomputing aggregate information describing links for the particular feature; and
recomputing the priority for the particular feature based on the recomputed aggregate information describing links for the particular feature.

17. The non-transitory computer readable storage medium of claim 10, wherein the plurality of features form a feature hierarchy, wherein the prompt comprises, for each of the one or more features, information describing a position of the feature in the feature hierarchy.

18. The non-transitory computer readable storage medium of claim 10, wherein a comment received from a user represents:
an email communication received from the user,
a natural language text received from the user via a chat interface, or
a transcript of a call received from the user.

19. A computer system comprising:
one or more computer processors; and
a non-transitory computer readable storage medium storing instructions that when executed by one or more computer processors cause the one or more computer processors to perform steps comprising:
storing, by an online system, information describing an item, the information comprising a plurality of features of the item;
receiving a plurality of comments from users, each comment representing user feedback received via a channel from a plurality of channels of the online system;
linking comments from the plurality of comments with features of the plurality of features, comprising:
generating a vector representation of each of the plurality of comments;
generating a vector representation of each of the plurality of features;
for each of the plurality of features,
identifying a set of comments whose vector representations are similar to the vector representation of the feature;
generating a prompt for input to a machine learning based language model, the prompt describing the feature and corresponding one or more comments whose vector representations are identified as similar to the vector representation of the feature, the prompt instructs the machine learning based language model to determine whether each of the one or more comments is associated with the feature,
providing the prompt to the machine learning based language model for execution of the machine learning based language model,
receiving a response generated by the machine learning based language model based on the prompt, the response describing an association between the feature and at least one of the one or more comments, and
storing a link representing the association between the feature and the at least one of the one or more comments;
determining aggregate information describing linked one or more comments for each feature from the plurality of features;
determining a priority for a feature from the plurality of features based on the aggregate information describing the linked one or more comments for the feature; and
in response to determining the feature as high-priority, prioritizing processing of incoming comments associated with the feature.

20. The computer system of claim 19, wherein the plurality of features form a feature hierarchy, wherein the prompt comprises, for each of the one or more features, information describing a position of the feature in the feature hierarchy.
